(19) United States
(12) Patent Application Publication
(10) Pub. No.: US 2020/0134697 A1
(43) Pub. Date: Apr. 30, 2020

(54) APPARATUS AND METHOD FOR OFFERING PURCHASE SUPPORT

(71) Applicant: TOSHIBA TEC KABUSHIKI KAISHA, Tokyo (JP)

(72) Inventors: Ryuichi AOYAMA, Mishima Shizuoka (JP); Akihiko FUJIWARA, Kawasaki Kanagawa (JP); Mika HIRAMA, Kokubunji Tokyo (JP); Masami TAKAHATA, Setagaya Tokyo (JP)

(21) Appl. No.: 16/578,000

(22) Filed: Sep. 20, 2019

(30) Foreign Application Priority Data
Oct. 24, 2018 (JP) 2018-200023

(51) Int. Cl. G06Q 30/06; G06Q 20/32; G06K 9/00

(52) U.S. Cl. CPC G06Q 30/0633; G06K 9/00671; G06Q 20/322

(57) ABSTRACT

A purchase support system includes a server including a memory storing a list of commodities and purchase conditions specified by a customer, and a first processor, and a terminal including a display, a camera acquiring an image, and a second processor transmitting the image to the server. The first processor, upon receipt of the image from the terminal, identifies commodities in the image, determines first commodities that are included in the list of commodities and are also identified in the image, generates second information indicating where the first commodities are displayed, and transmits the first and second information to the terminal, and the second processor, upon receipt of the first and second information, controls the display to display, in the image, guidance images each indicating a location of a first commodity and whether the first commodity satisfies the purchase condition.

### CROSS-REFERENCE TO RELATED APPLICATION

This application is based upon and claims the benefit of priority from Japanese Patent Application No. 2018-200023, filed on Oct. 24, 2018, the entire contents of which are incorporated herein by reference.

### FIELD

Embodiments described herein relate generally to an apparatus and method for offering purchase support.

### BACKGROUND

A mobile terminal such as a smartphone has a function for generating a purchase list which lists commodities that a customer plans to purchase. By combining the functions for generating the purchase list and augmented reality (AR), a shopping support method has been developed in which, when the customer captures an image inside a retail store, guidance information about the listed commodity is superimposed on the image. However, a grocery store often displays different brands or grades of the same commodity at different locations. Thus, the guidance based solely on the commodity name may not help the customer in finding exactly what he or she wants.

### DESCRIPTION OF THE DRAWINGS

FIG. 1 is a diagram schematically illustrating a commodity sales processing system according to one embodiment;

FIG. 2 is a block diagram illustrating a circuit configuration of a user terminal in the commodity sales processing system;

FIG. 3 is a diagram illustrating a data structure of a purchase plan record stored in the user terminal;

FIG. 4 is a block diagram illustrating a circuit configuration of an in-store terminal in the commodity sales processing system;

FIG. 5 is a schematic view illustrating a data structure of an indication data record stored in the in-store terminal;

FIG. 6 is a block diagram illustrating a circuit configuration of a server in the commodity sales processing system;

FIG. 7 is a schematic view illustrating a data structure of a commodity data record stored in a commodity database;

FIG. 8 is a schematic view illustrating a data structure of a shelf data record stored in a shelf database;

FIG. 9 is a schematic view illustrating a data structure of a purchase support data record stored in a purchase support file;

FIG. 10 is a schematic view illustrating a data structure of a registered commodity data record stored in a registered commodity file;

FIG. 11 is a flowchart depicting a processing executed by the server;

FIG. 12 is a flowchart depicting a processing executed by the server;

FIG. 13 is a flowchart depicting a processing executed by the server;

FIG. 14 is a flowchart depicting a processing executed by the server;

FIG. 15 is a flowchart depicting a processing executed by the in-store terminal at the time of receiving the indication data record;

FIG. 16 is a schematic view illustrating an indication image;

FIG. 17 is a schematic view illustrating a screen on which the indication image is displayed by being superimposed on a real time image;

FIG. 18 is a schematic view illustrating another screen on which the indication image is displayed by being superimposed on a real time image; and

FIG. 19 is a schematic view illustrating transition of a purchase list image.

### DETAILED DESCRIPTION

In accordance with an embodiment, a purchase support system includes a server including a memory that stores a list of commodities and respective purchase conditions specified by a customer, a first network interface, and a first processor; and a terminal including a display, a camera configured to acquire an image, a second network interface, and a second processor configured to control the second network interface to transmit the acquired image to the server. The first processor is configured to, upon receipt of the image from the terminal, identify one or more commodities included in the image, determine first commodities that are included in the list of commodities and are also identified in the image, generate first information indicating whether or not the first commodities satisfy the respective purchase conditions, generate second information indicating where the first commodities are displayed, and control the first network interface to transmit the first and second information to the terminal, and the second processor is further configured to upon receipt of the first and second information, control the display to display, in the acquired image, one or more guidance images each indicating a location of one of the first commodities and whether or not the first commodity satisfies the corresponding purchase condition.

Hereinafter, embodiments of a purchase support apparatus capable of effectively offering purchase support are described with reference to the accompanying drawings. Such embodiments are examples of applying a purchase support apparatus to a self-service type commodity sales processing system using an in-store terminal. The in-store terminal is attached to a shopping cart. A customer who is a purchaser operates the in-store terminal to register sales data of a commodity to be purchased by himself/herself. A customer who finishes the registration operates a dedicated checkout apparatus installed in a retail store to perform checkout on the registered commodity. In one embodiment, in such a self-service type commodity sales processing system, the purchase support apparatus provides information relating to purchase support through the in-store terminal to offer purchase support to the customer.

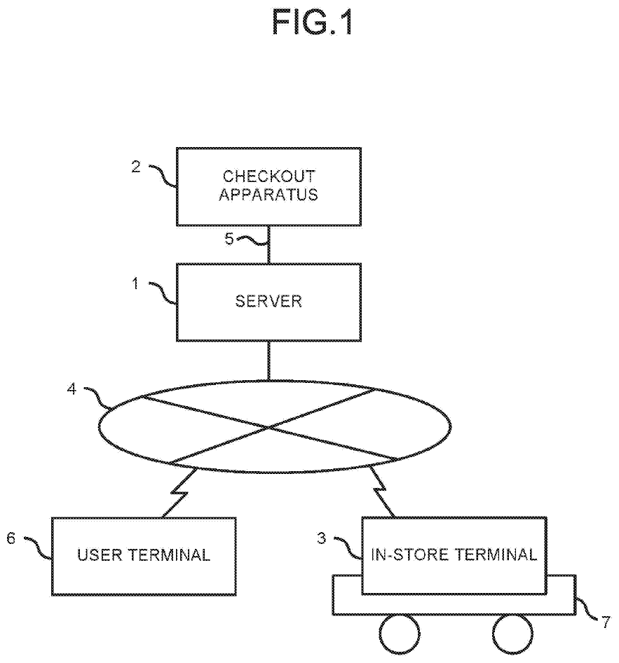

FIG. 1 is a diagram schematically illustrating a configuration of the commodity sales processing system according to one embodiment. Such a system includes a server 1, a checkout apparatus 2, an in-store terminal 3, a network 4, a communication line 5 and a user terminal 6. The server 1, the checkout apparatus 2, the in-store terminal 3, the network 4 and the communication line 5 are provided in a retail store in which purchase support is offered. The user terminal 6 is possessed by a customer who accepts the purchase support. The user terminal 6 may be lent from the retail store by the customer who accepts the purchase support.

The server 1 is a computer that plays a central role in a commodity sales processing. The checkout apparatus 2 is operated by the customer to perform checkout. The checkout apparatus 2 is installed at a predetermined location in the retail store. The server 1 and the checkout apparatus 2 are connected via a dedicated communication line 5. The server 1 transmits data necessary for checkout performed by the customer to the checkout apparatus 2 through the communication line 5. The checkout apparatus 2 performs a checkout processing on a commodity based on the data received from the server 1.

The server 1 is connected with the in-store terminal 3 and the user terminal 6 via the network 4. The network 4 is, for example, a wireless LAN (Local Area Network).

The in-store terminal 3 is attached to a shopping cart 7. The in-store terminal 3 is used by a customer who uses the shopping cart 7 to shop in the retail store. The in-store terminal 3 includes a device necessary for registration of a commodity. Furthermore, the in-store terminal 3 includes a wireless communication device to perform wireless data communication with the server 1 connected thereto via the network 4. The in-store terminal 3 transmits data relating to the registration of the commodity to the server 1 via the network 4. The data relating to the registration of the commodity is, for example, a commodity code. The commodity code is uniquely set for each commodity to identify the commodity. The data relating to the registration of the commodity may include a quantity which is the number of commodities having the same commodity code.

The user terminal 6 is a portable information terminal having a function of electronically generating a purchase list that lists commodities that the customer plans to purchase. The user terminal 6 includes a wireless communication device to perform wireless data communication with the server 1 connected thereto via the network 4. The user terminal 6 transmits the data relating to the purchase list to the server 1 via the network 4. For example, the user terminal 6 may be a smartphone, a tablet PC (Personal Computer), etc.

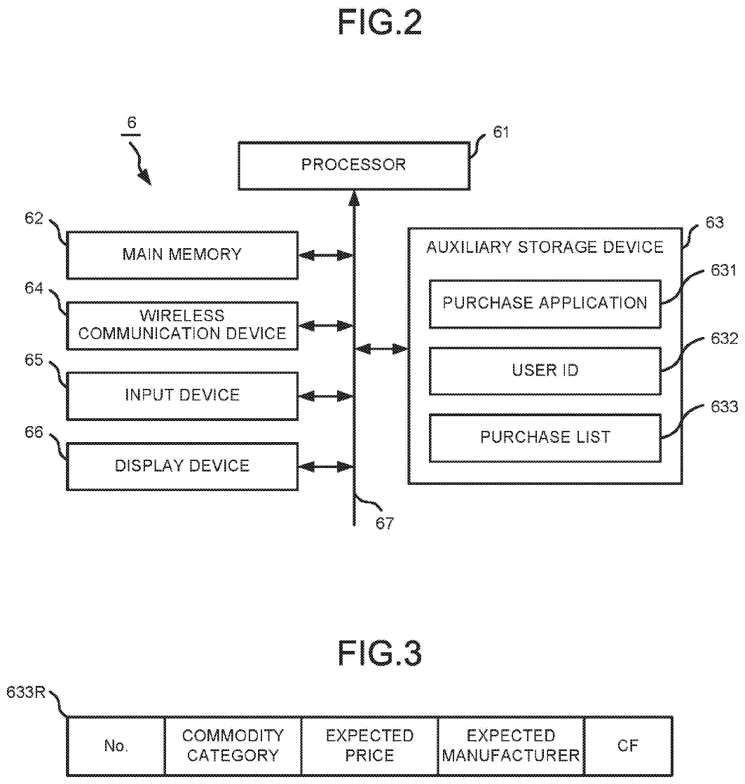

FIG. 2 is a block diagram illustrating a circuit configuration of the user terminal 6. The user terminal 6 includes a processor 61, a main memory 62, an auxiliary storage device 63, a wireless communication device 64, an input device 65, a display device 66 and a system transmission line 67. The system transmission line 67 includes an address bus, a data bus, a control signal line and the like. The system transmission line 67 connects the processor 61 with other sections directly or indirectly through a signal input/output circuit to perform transmission and reception of data signal therebetween. The processor 61, the main memory 62 and the auxiliary storage device 63 are connected via the system transmission line 67.

The processor 61 acts as a central component of the computer. The processor 61 controls each section to perform various functions of the user terminal 6 according to an operating system or application programs. The processor 61 is, for example, a CPU (Central Processing Unit).

The main memory 62 includes a non-volatile memory area and a volatile memory area. The main memory 62 stores the operating system or application programs in the non-volatile memory area. The main memory 62 may store data necessary for the processor 61 to control each component of the user terminal, in the non-volatile or volatile memory area. The main memory 62 uses the volatile memory area as a work area in which data is appropriately rewritten by the processor 61. The non-volatile memory area is, for example, a ROM (Read Only Memory). The volatile memory area is, for example, a RAM (Random Access Memory).

The auxiliary storage device 63 acts as an auxiliary storage component of the computer. For example, the auxiliary storage device 63 may be an EEPROM (Electric Erasable Programmable Read-Only Memory), an HDD (Hard Disk Drive), an SSD (Solid State Drive), or the like. The auxiliary storage device 63 stores data to be used at the time the processor performs various processing, data generated in a processing by the processor 61, and the like. The auxiliary storage device 63 may store the application programs described above.

The wireless communication device 64 performs data communication in conformity to a wireless communication protocol. The processor 61 controls the wireless communication device 64 to perform data communication with the server 1 via the network 4.

The input device 65 receives an operation input from a user. The display device 66 displays information to the user. The input device 65 and the display device 66 are integrated with each other to make up, for example, a touch panel. The input device 65 and the display device 66 may be a keyboard and a liquid crystal display, respectively.

The user terminal 6 having such a configuration stores an application program for electronically generating a purchase list in the auxiliary storage device 63. Hereinafter, the application program is referred to as a purchase application 631. The purchase application 631 can be installed on the user terminal 6 from a website via the Internet, for example. By installing the purchase application 631, a part of a storage area of the auxiliary storage device 63 becomes a user ID memory area 632 and a purchase list memory area 633.

The customer who is the user of the user terminal 6 starts the purchase application 631 to prepare the purchase list. If the purchase application 631 is started, the processor 61 first controls the input device 65 to receive an input of a user ID according to the purchase application 631. The user ID is uniquely set for each customer to identify the customer. The customer operates the input device 65 to input the user ID. If the user ID is input, the processor 61 stores the input user ID in the user ID memory area 632.

The processor 61 controls the input device 65 to receive the input of the purchase list according to the purchase application 631. Specifically, the processor 61 controls the input device 65 to receive an input of a category, an expected price and an expected provider of a commodity (e.g., a producer of a manufacturer) that the customer plans to purchase.

The commodity category represents a classification of the commodity. If commodities having different commodity names belong to the same classification, the commodity category is common. For example, in the case of “orange” which is a fruit, a commodity name thereof differs depending on a production area, such as “orange produced in AA” and “orange produced in BB”. However, the classification of the commodities having different commodity names is “orange”. The commodity category of both “orange produced in AA” and “orange produced in BB” is “orange”. Similarly, in the case of “potato chips” which are a confectionery, a commodity name thereof differs depending on a manufacturer, such as “potato chips manufactured by CC” and “potato chips manufactured by DD”. However, the classification of the commodities having different commodity names is “potato chips”. The commodity category of both “potato chips manufactured by CC” and “potato chips manufactured by DD” is “potato chips”.

The expected price is price information serving as a criterion for the customer to purchase a commodity. The expected manufacturer is information relating to a production area or a manufacturer of the commodity that the customer intends to purchase.

The customer designates a commodity that he/she plans to purchase according to the commodity category, the expected price and the expected manufacturer. If there is no criterion price, the customer inputs “none” in a field of the expected price. If there is no expectation relating to the production area or manufacturer of the commodity, the customer inputs “none” in a field of the expected manufacturer.

The processor 61 generates a purchase plan record 633R based on data of the commodity category, the expected price and the expected manufacturer input through the input device 65, and sequentially stores the generated purchase plan records 633R in the purchase list memory area 633.

FIG. 3 is a diagram illustrating a data structure of the purchase plan record 633R. As shown in FIG. 3, in the purchase plan record 633R, a record number “No.” and a check flag “CF” are added to data input to fields of the commodity category, the expected price and the expected manufacturer. The record number indicates a sequence number of the entry in the purchase list memory area 633. The check flag CF is 1-bit data for identifying whether or not the customer has taken the commodity managed through the purchase plan record 633R, and has a default value indicating that the customer does not take the commodity. In the present embodiment, a value of the check flag CF is set to “1” when the customer has already taken the commodity, and a value of the check flag CF is set to “0” when the customer has not taken the commodity. Here, the commodity taken by the customer is a commodity placed in the shopping cart 7 by the customer.

Thus, the purchase plan record 633R relating to the commodity that the customer intends to purchase is registered in the purchase list memory area 633. In other words, the purchase list is an aggregate of the purchase plan records 633R. The modification and deletion of the purchase plan record 633R can be appropriately performed through the function of the purchase application 631.

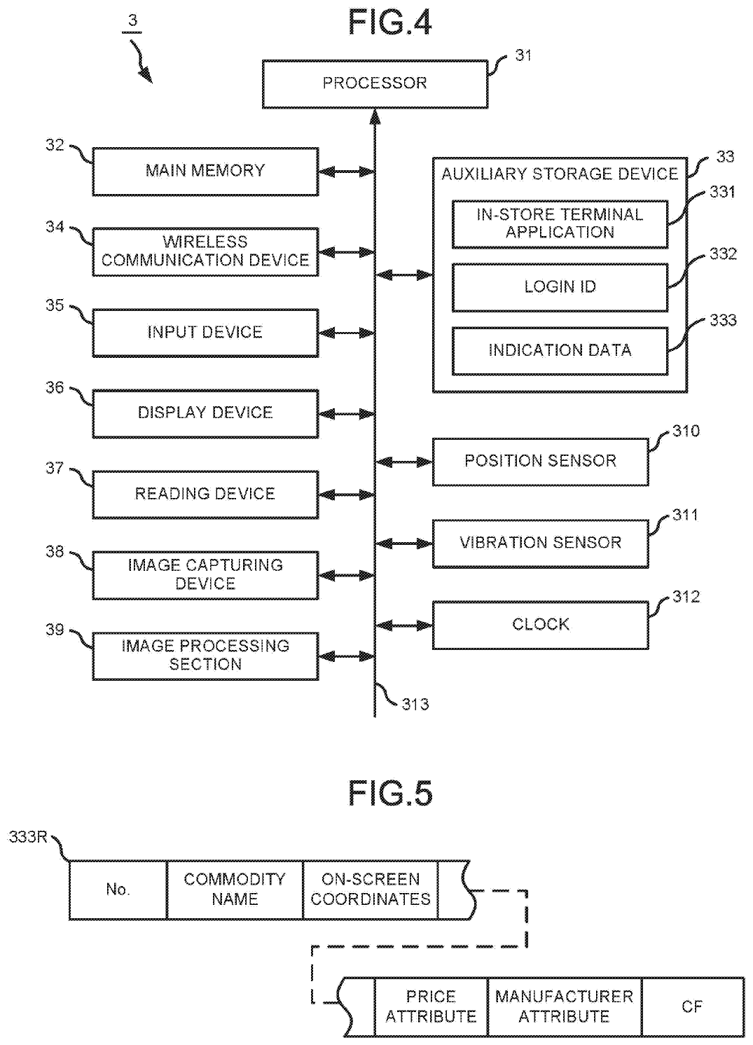

FIG. 4 is a block diagram illustrating a circuit configuration of the in-store terminal 3. The in-store terminal 3 includes a processor 31, a main memory 32, an auxiliary storage device 33, a wireless communication device 34, an input device 35, a display device 36, a reading device 37, an image capturing device 38, an image processing section 39, a position sensor 310, a vibration sensor 311, a clock 312 and a system transmission line 313. The system transmission line 313 includes an address bus, a data bus, a control signal line and the like. The system transmission line 313 connects the processor 31 with other components directly or indirectly through a signal input/output circuit to perform transmission and reception of data signals therebetween. The processor 31, the main memory 32 and the auxiliary storage device 33 are connected via the system transmission line 313.

The processor 31, the main memory 32 and the auxiliary storage device 33 have the similar functions as the processor 61, the main memory 62 and the auxiliary storage device 63 of the above-described user terminal 6 except that the processor 31 controls each component to perform various functions of the in-store terminal 3. Therefore, the overlapping description is omitted here.

The wireless communication device 34 performs data communication in conformity with a wireless communication protocol. The processor 31 controls the wireless communication device 34 to perform data communication with the server 1 via the network 4.

The input device 35 receives an operation input from a user. The display device 36 displays information to the user. The input device 35 and the display device 36 are integrated with each other to make up a touch panel, for example. The input device 35 and the display device 36 may be a keyboard and a liquid crystal display, respectively.

The reading device 37 reads a code symbol such as a barcode or a two-dimensional data code. The reading device 37 may read a code symbol by performing scanning with a laser beam, or may read a code symbol from an image captured through a camera. A code symbol representing a commodity code is attached to each commodity.

The image capturing device 38 captures images in a moving direction of the shopping cart 7 at a constant interval. Generally, the customer who shops in the retail store using the shopping cart 7 wanders around the retail store while holding a handle of the shopping cart 7 and pushing the shopping cart 7 forwards. An advancing direction of the shopping cart 7 at this time is defined as the moving direction. The image capturing device 38 is attached to a part of the shopping cart 7, and captures in-store images in the moving direction, for example, every one second. The image capturing device 38 is, for example, a CCD (Charge Coupled Device) camera.

The image processing section 39 performs an image processing for enabling the display device 36 to display a real time image captured by the image capturing device 38. The image processing section 39 performs an image processing such that an AR image is superimposed on the real time image using an augmented reality technology to be displayed. The both image processing can be performed using known technology.

The position sensor 310 detects a position of the in-store terminal 3 moving along with the shopping cart 7 in the retail store. The position sensor 310 is, for example, a GPS (Global Positioning System) sensor.

The vibration sensor 311 detects vibration of the in-store terminal 3 moving along with the shopping cart 7. The vibration sensor 311 is, for example, an acceleration sensor.

The clock 312 counts date and time. The processor 31 processes the date and time counted by the clock 312 as the current date and time.

The in-store terminal 3 having such a configuration stores an application program for performing the function of the in-store terminal 3 in the auxiliary storage device 33. Hereinafter, such an application program is referred to as an in-store terminal application 331. The in-store terminal application 331 is installed in advance in the in-store terminal 3. By installing the in-store terminal application 331, a part of a storage area of the auxiliary storage device 33 becomes a login ID memory area 332 and an indication data memory area 333.

If the customer who is the user of the shopping cart 7 pushes the shopping cart 7 from a cart storage position, the vibration sensor 311 detects the vibration. If such a detection signal is transmitted to the processor 31 in an idle state, the processor 31 starts the in-store terminal application 331.

If the in-store terminal application 331 is started, the processor 31 receives an input of a login ID according to the in-store terminal application 331. The login ID is uniquely set for each customer to identify the customer. The login ID is coincident with the user ID described above. The customer operates the input device 35 to input the login ID. If the login ID is input, the processor 31 stores the login ID in the login ID memory area 332. The processor 31 then starts the reading device 37 and the image capturing device 38.

After the login ID has been input, the customer wanders around the retail store while pushing the shopping cart 7. If the customer finds a commodity he/she intends to purchase, the customer uses the reading device 37 to read the code symbol attached to the commodity and then places the commodity in the shopping cart 7. If the code symbol is read through the reading device 37, the processor 31 wirelessly transmits the data of the code symbol to the server 1. The processor 31 then enables an operation of a checkout button. The checkout button can be operated via the input device 35. After shopping, the customer operates the checkout button.

If the code symbol is read through the reading device 37 in a state in which the operation of the checkout button is enabled, the processor 31 wirelessly transmits the data of the code symbol to the server 1. On the other hand, if the checkout button is operated, the processor 31 wirelessly transmits a checkout command to the server 1. The checkout command includes the login ID stored in the login ID memory area 332.

In parallel with the above processing, the processor 31 wirelessly transmits data of images captured at a certain span by the image capturing device 38 to the server 1. The server 1 generates one or more indication data records 333R based on the image data, and wirelessly transmits the indication data records 333R to the in-store terminal 3 that transmits the image data. The processor 31 overwrites the indication data memory area 333 with the indication data record 333R received from the server 1 to store the indication data record 333R. The indication data record 333R records information necessary for editing an AR image displayed by being superimposed on the real time image captured by the image capturing device 38. Hereinafter, the AR image edited based on the indication data record 333R is referred to as an indication image.

FIG. 5 is a schematic view illustrating a data structure of the indication data record 333R. The indication data record 333R includes a record number, a commodity name, on-screen coordinates, a price attribute, a manufacturer attribute and a check flag CF.

The record number is a consecutive number starting with “1” set to individually identify the indication data record 333R. The commodity name is text data to be inserted into the indication image. The on-screen coordinates specify a display position of the indication image on a screen of the display device 36. The price attribute identifies whether or not a condition relating to the price is satisfied. In the present embodiment, a value of the price attribute at the time the condition is satisfied is “1”, and a value of the price attribute at the time the condition is not satisfied is “0”. The manufacturer attribute identifies whether or not the condition relating to the manufacturer is satisfied. In the present embodiment, a value of the manufacturer attribute at the time the condition is satisfied is “1”, and a value of the manufacturer attribute at the time the condition is not satisfied is “0”. The check flag CF is the same as the check flag CF included in the purchase plan record 633R.

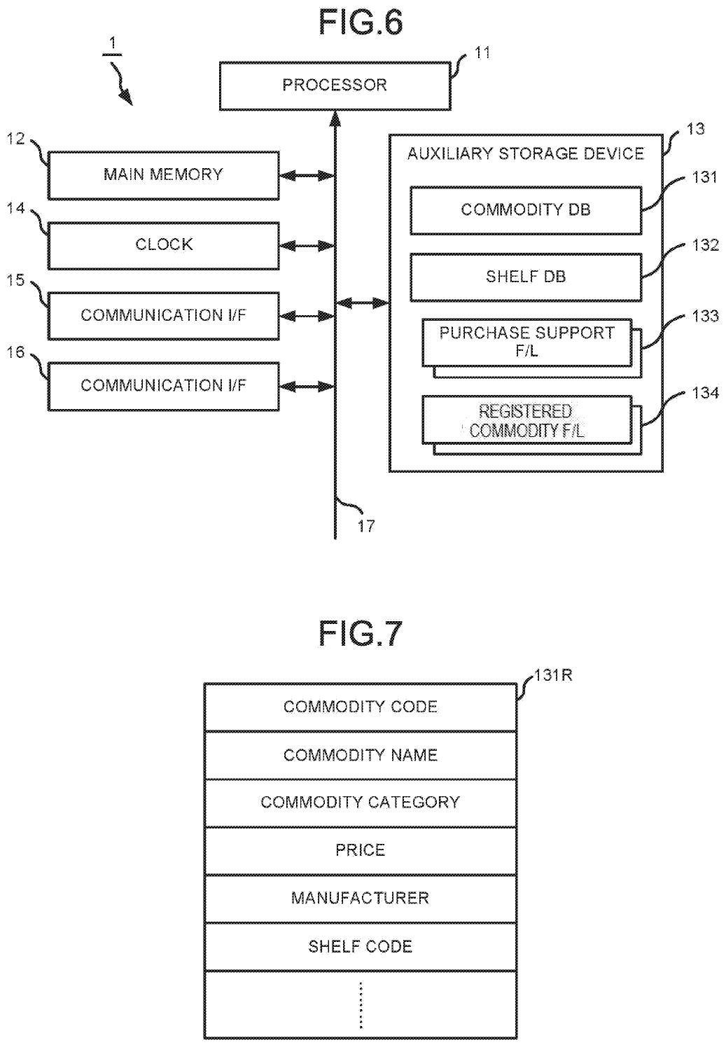

FIG. 6 is a block diagram illustrating a circuit configuration of the server 1. The server 1 includes a processor 11, a main memory 12, an auxiliary storage device 13, a clock 14, a first communication interface 15, a second communication interface 16 and a system transmission line 17. The system transmission line 17 includes an address bus, a data bus, a control signal line and the like. The system transmission line 17 connects the processor 11 and other sections directly or indirectly through a signal input/output circuit to perform transmission and reception of data signals therebetween. The processor 11, the main memory 12 and the auxiliary storage device 13 are connected via the system transmission line 17.

The processor 11, the main memory 12 and the auxiliary storage device 13 have the similar functions as the processor 61, the main memory 62 and the auxiliary storage device 63 of the above-described user terminal 6 except that the processor 11 controls each section to perform various functions of the server 1. Therefore, the overlapping description is omitted here.

The clock 14 counts date and time. The processor 11 processes the date and time counted by the clock 14 as the current date and time.

The first communication interface 15 is connected to the network 4. The first communication interface 15 performs data communication with the in-store terminal 3 or the user terminal 6 connected thereto via the network 4. The first communication interface 15 functions as a receiving module for receiving an image signal from the image capturing device 38 attached to the shopping cart 7.

The second communication interface 16 is connected to the communication line 5. The second communication interface 16 performs data communication with the checkout apparatus 2 connected thereto via the communication line 5.

The server 1 having such a configuration uses a part of a storage area of the auxiliary storage device 13 as areas for storing a commodity database 131, a shelf database 132, a purchase support file 133 and a registered commodity file 134.

The commodity database 131 stores a commodity data record 131R for each commodity. The commodity data record 131R records data relating to the commodity for each commodity sold in the retail store.

FIG. 7 is a schematic view illustrating a data structure of the commodity data record 131R. As shown in FIG. 7, the commodity data record 131R includes data items such as a commodity code, a commodity name, a commodity category, a price, a manufacturer, a shelf code and the like. The commodity name, the commodity category, the price, the manufacturer and the shelf code are a part of the data relating to the commodity identified by the commodity code. The price is a selling price. The manufacturer identifies a production area or a manufacturer. The shelf code identifies a commodity shelf where the commodity is displayed. The number of the shelf codes is not limited to one. If the commodity is displayed across a plurality of commodity shelves, each shelf code is included in the commodity data record 131R.

The shelf database 132 stores a shelf data record 132R for each commodity shelf. The commodity shelf refers to an area of a shelf where commodities belonging to one classification are displayed. Therefore, there are a number of commodity shelves in the retail store in correspondence with the classification of the commodity. The shelf data record 132R records data relating to the commodity shelf.

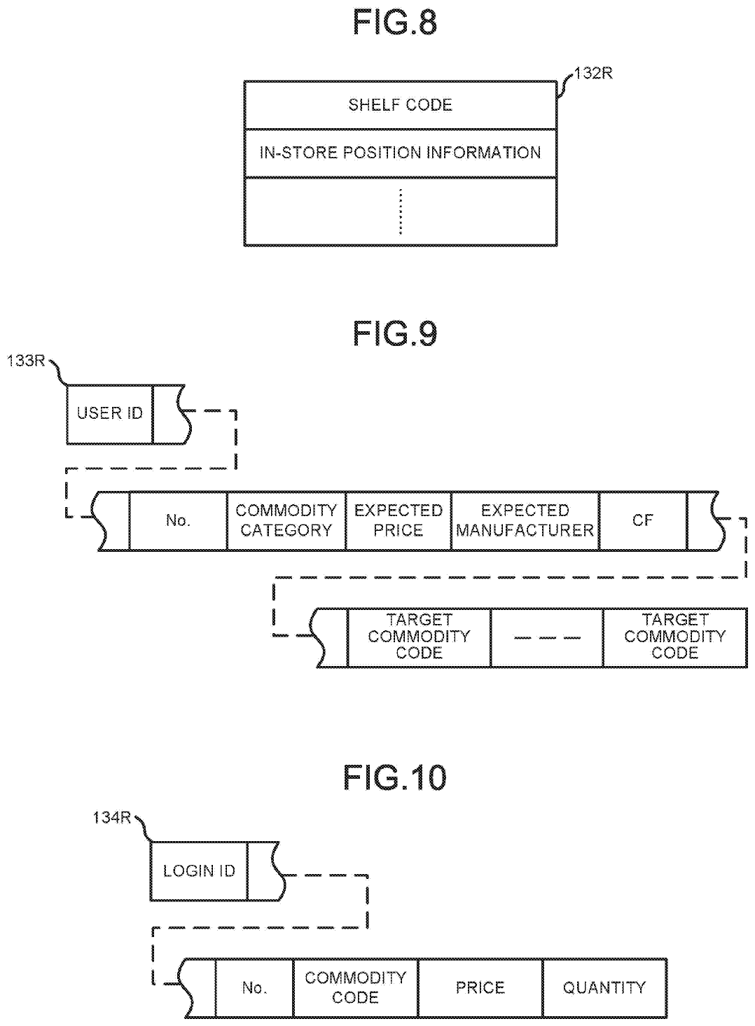

FIG. 8 is a schematic view illustrating a data structure of the shelf data record 132R. As shown in FIG. 8, the shelf data record 132R includes a shelf code and in-store position information. The shelf code is uniquely set for each commodity shelf to individually identify the commodity shelf. The in-store position information specifies an in-store position of the commodity shelf specified by the shelf code. For example, the in-store position information includes a height of an upper surface of the commodity shelf at the time a height of a floor surface is set as a reference height of 0 cm and an XY coordinate of the upper surface of the commodity shelf at the time a floor surface is set as an XY plane and the reference position on the floor surface is set as the origin with coordinates of (0, 0).

The purchase support file 133 is generated in the auxiliary storage device 13 each time the customer accepts the purchase support. The purchase support file 133 stores one or more purchase support data records 133R generated based on the purchase list of the customer.

FIG. 9 is a schematic view illustrating a data structure of the purchase support data record 133R. As shown in FIG. 9, the purchase support data record 133R includes a user ID, a record number, a commodity category, an expected price, an expected manufacturer, a check flag CF, and a target commodity code. The user ID is an ID assigned to a customer. The record number, the commodity category, the expected price, the expected manufacturer and the check flag CF are data included in the purchase list of the customer identified by the user ID, i.e., the purchase plan record 633R. The target commodity code is a commodity code of a commodity belonging to the same commodity category. If there is a plurality of commodities belonging to the same commodity category, each commodity code is included in the purchase support data record 133R as a target commodity code.

The registered commodity file 134 is generated in the auxiliary storage device 13 each time the customer uses the in-store terminal 3. The registered commodity file 134 stores a registered commodity data record 134R generated for each commodity taken by the customer, i.e., each commodity placed in the shopping cart 7.

FIG. 10 is a schematic view illustrating a data structure of the registered commodity data record 134R. As shown in FIG. 10, the registered commodity data record 134R includes a login ID, a record number, a commodity code, a price and a quantity. The login ID is used at the time the customer using the in-store terminal 3 logs in to the in-store terminal 3. The record number is a consecutive number starting with “1”. The commodity code, the price and the quantity are information relating to the commodity taken by the customer.

The server 1 having such a configuration cooperates with the user terminal 6 and the in-store terminal 3 to function as a purchase support apparatus. Specifically, the server 1 offers the purchase support to a customer who prepares the purchase list using the user terminal 6 by enabling the display device 36 of the in-store terminal 3 attached to the shopping cart 7 used by the customer to display an indication image for guiding the customer to a place where the commodity in the purchase list is displayed. The indication image is displayed by being superimposed on the real time image, which shows the inside of the retail store and is captured by the image capturing device 38 of the in-store terminal 3, based on the data of the indication data record 333R described above.

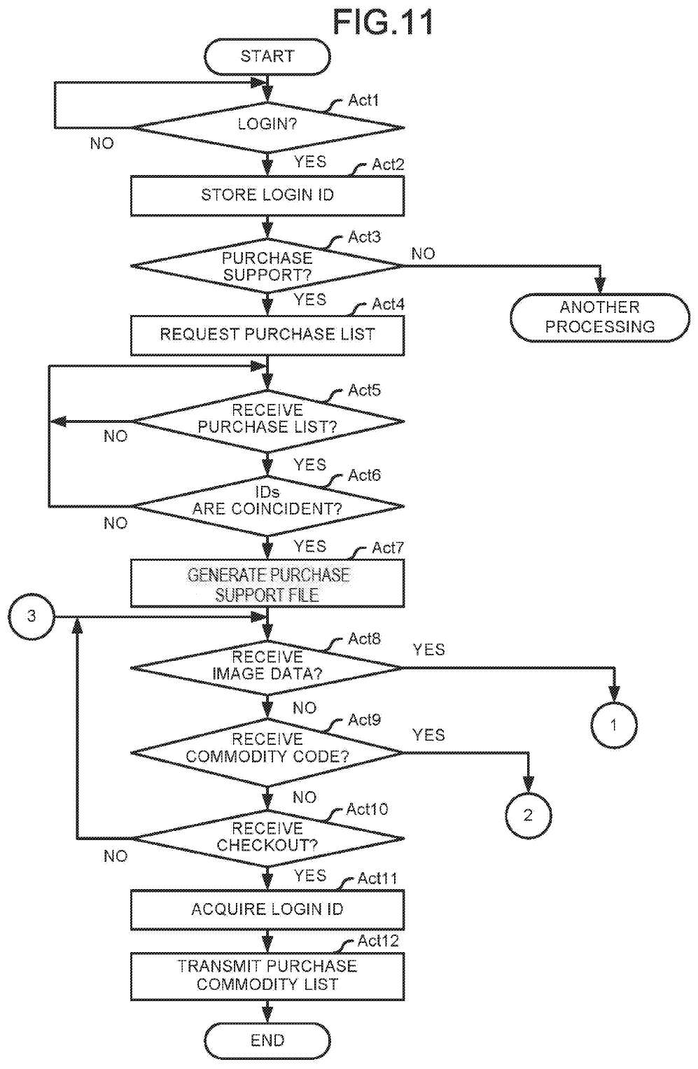

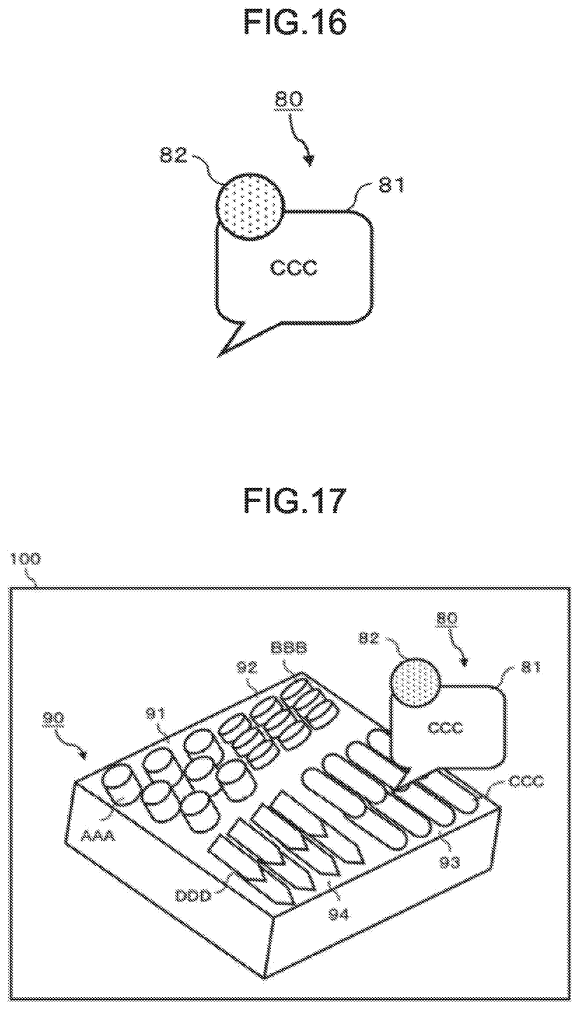

Hereinafter, the function of the purchase support apparatus performed by the server 1 is described using the flowcharts in FIG. 11 to FIG. 15 and display examples in FIG. 16 to FIG. 18.

FIG. 11 to FIG. 14 are flowcharts depicting a processing executed by the server 1 according to programs. The programs are stored in the main memory 12 or the auxiliary storage device 13. The contents of the processing shown in the flowcharts in FIG. 11 to FIG. 14 and described below are merely an example. The procedures of the processing are not particularly limited as long as the same result can be achieved.

The processor 11 stands by until login from the in-store terminal 3 is performed in Act 1. In the in-store terminal 3, if a login ID is input, the processor 31 of the in-store terminal 3 controls the wireless communication device 34 to transmit a login command. Through this control, the wireless communication device 34 wirelessly transmits the login command including the login ID to the server 1.

If the login command is received via the first communication interface 15, the processor 11 of the server 1 takes Yes in Act 1, and then proceeds to the processing in Act 2. The processor 11 stores the login ID included in the login command in the volatile memory area of the main memory 12 in Act 2.

The processor 11 stands by until an input relating to whether to offer the purchase support from the in-store terminal 3 is performed in Act 3. If the login ID is input, the processor 31 of the in-store terminal 3 controls the display device 36 to display a selection screen relating to whether to accept the purchase support. The customer who is the user of the in-store terminal 3 determines whether to accept the purchase support. The customer who has prepared the purchase list using the user terminal 6 can accept the purchase support. In a case of accepting the purchase support, the customer operates the input device 35 to perform a selection operation to accept the purchase support. On the other hand, the customer who has not prepared the purchase list or the customer who has prepared the purchase list but does not require the purchase support operates the input device 35 to perform a selection operation not to accept the purchase support.

The processor 31 of the in-store terminal 3 that receives the selection operation to accept the purchase support controls the wireless communication device 34 to transmit a purchase support command. Through this control, the wireless communication device 34 wirelessly transmits the purchase support command to the server 1. On the other hand, the processor 31 of the in-store terminal 3 that receives the selection operation not to accept the purchase support does not control the wireless communication device 34 to transmit the purchase support command.

If a command other than the purchase support command is received via the first communication interface 15, the processor 11 of the server 1 takes No in Act 3, and then executes another processing. Another processing in this case includes a self-registration processing and a checkout processing performed through the in-store terminal 3. The self-registration processing and the checkout processing are known processing in an existing self-service type commodity sales processing system using the in-store terminal, and thus the description thereof is omitted here.

If the purchase support command is received via the first communication interface 15, the processor 11 of the server 1 takes Yes in Act 3, and then proceeds to the processing in Act 4. The processor 11 controls the first communication interface 15 to transmit a command for requesting the purchase list to the in-store terminal 3 in Act 4. Through this control, the first communication interface 15 wirelessly transmits the command for requesting the purchase list through the network 4. The request command is received by the in-store terminal 3 that transmits the purchase support command.

If the command of requesting the purchase list is received via the wireless communication device 34, the processor 31 of the in-store terminal 3 controls the display device 36 to display a guidance for instructing the customer to transmit the purchase list. The customer who has confirmed the guidance operates the user terminal 6 to transmit the purchase list to the server 1. Through this operation, the data of the purchase plan record 633R stored in the purchase list memory area 633 is wirelessly transmitted from the user terminal 6 together with the user ID stored in the user ID memory area 632. The data wirelessly transmitted from the user terminal 6 is received by the server 1 via the network 4.

The processor 11 of the server 1 that has transmitted the purchase list request command stands by until the purchase list is received in Act 5. If the user ID and the data of the purchase plan record 633R are received through the first communication interface 15, the processor 11 takes Yes in Act 5, and then proceeds to the processing in Act 6. The processor 11 determines whether or not the user ID received from the user terminal 6 is coincident with the login ID stored in Act 2 in Act 6. If the user ID and the login ID are not coincident with each other, the processor 11 takes No in Act 6, and then returns to the processing in Act 5.

Here, in Act 5 and Act 6, the processor 11 stands by until the purchase list, i.e., the data of the purchase plan record 633R is received from the user terminal 6 in which the user ID coincident with the login ID is set. If the data of the purchase plan record 633R in which the user ID is coincident with the login ID is received via the first communication interface 15, the processor 11 takes Yes in Act 6, and then proceeds to the processing in Act 7.

The processor 11 generates the purchase support file 133 in the auxiliary storage device 13 based on the data of the purchase plan record 633R in Act 7. Specifically, the processor 11 adds the user ID and the check flag CF whose value is “0” to the data of the purchase plan record 633R. The processor 11 retrieves the commodity database 131 with the commodity category included in the purchase plan record 633R. Then, the processor 11 extracts all the commodity data records 131R belonging to the same commodity category, and adds the commodity codes in the commodity data records 131R to the data of the purchase plan record 633R as target commodity codes.

After the purchase support file 133 has been generated, the processor 11 determines whether or not the image data is received from the in-store terminal 3 in Act 8. If no image data is received, the processor 11 takes No in Act 8, and then proceeds to the processing in Act 9. The processor 11 determines whether or not the commodity code is received from the in-store terminal 3 in Act 9. If no commodity code is received, the processor 11 takes No in Act 9, and then proceeds to the processing in Act 10. The processor 11 determines whether or not a checkout command is received from the in-store terminal 3 in Act 10. If no checkout command is received, the processor 11 takes No in Act 10, and then returns to the processing in Act 8. Here, in Act 8 to Act 10, the processor 11 stands by until the image data, the commodity code or the checkout command is received from the in-store terminal 3.

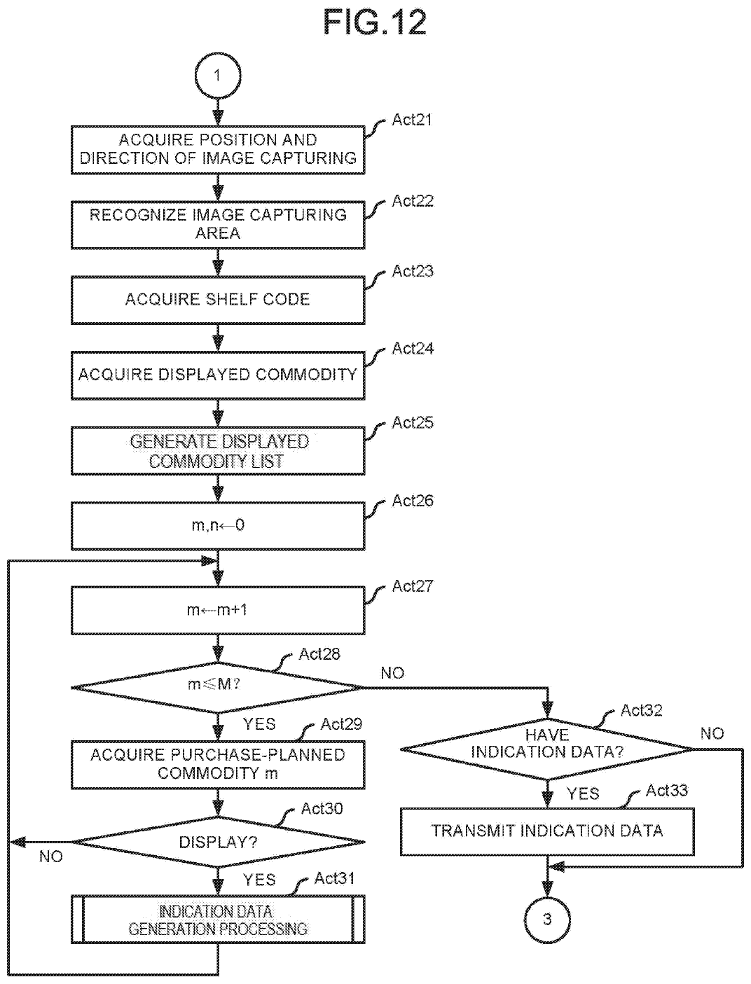

As described above, the image data captured by the image capturing device 38 is wirelessly transmitted from the in-store terminal 3 in which the login ID is input to the server 1 at a certain span. The image data includes position data detected by the position sensor 310. If the image data is received through the first communication interface 15, the processor 11 takes Yes in Act 8, and then proceeds to the processing in Act 21 in FIG. 12. The processor 11 obtains an image capturing position and an image capturing direction of the image capturing device 38 in Act 21. The image capturing position is specified from the position data received together with the image data. Since the moving direction of the shopping cart 7 is determined from a difference between the previous position data and the current position data, the moving direction is taken as the image capturing direction.

If the image capturing position and the image capturing direction of the image capturing device 38 are obtained, the processor 11 recognizes an image capturing area in the retail store in Act 22. An angle of view of the image capturing device 38 is constant. Therefore, an image capturing area at the time the image capturing is performed from the image capturing position at the angle of view along the image capturing direction is unambiguously determined. At the same time, on the display device 36 of the in-store terminal 3, a real time image showing the image capturing area is displayed.

If the image capturing area is recognized, the processor 11 refers to the shelf database 132 to acquire the shelf code of the commodity present in the image capturing area in Act 23. The shelf database 132 stores the shelf data record 132R in which the in-store position information is recorded in association with the shelf code of each commodity shelf. The processor 11 determines whether or not the in-store position specified by the in-store position information is included in the image capturing area. Then, the processor 11 acquires all the shelf codes included in the shelf data records 132R corresponding to the in-store positions included in the image capturing area.

After the shelf code has been acquired, the processor 11 refers to the commodity database 131 to acquire the commodity code for identifying the commodity displayed in the commodity shelf specified by the shelf code in Act 24. The commodity database 131 stores the commodity data record 131R in which the shelf code is recorded in association with the commodity code of each commodity. The processor 11 extracts all the commodity data records 131R having the shelf codes acquired in Act 23 to acquire the commodity codes from the commodity data records 131R.

After the commodity codes have been acquired, the processor 11 generates a displayed commodity list in Act 25. The displayed commodity list includes the commodity codes acquired in Act 24. The displayed commodity list is stored in the volatile memory area of the main memory 12.

Here, the processor 11 functions as a detection module for detecting a sales commodity shown in the image captured by the image capturing device 38 by executing the processing in Act 21 to Act 25.

After the displayed commodity list has been generated, the processor 11 initializes both a counter m and a counter n to “0” in Act 26. The values of the counters are stored in the volatile memory area of the main memory 12.

After the counters m and n have been initialized, the processor 11 counts up the counter m by “1” in Act 27. Then, the processor 11 determines whether or not the counter m is equal to or less than the number M of the purchase support data records 133R stored in the purchase support file 133 generated in Act 7 in FIG. 11 in Act 28.

If the counter m is equal to or less than the number M of the purchase support data records 133R, the processor 11 takes Yes in Act 28, and then proceeds to the processing in Act 29. The processor 11 extracts the purchase support data record 133R of which the record number is coincident with the counter m from the purchase support file 133 in Act 29. Then, the processor 11 determines whether or not the target commodity code included in the purchase support data record 133R is present in the displayed commodity list generated in Act 25 in Act 30. If no target commodity code is included in the displayed commodity list, the processor 11 takes No in Act 30, and then returns to the processing in Act 27.

On the other hand, if even one target commodity code is included in the displayed commodity list, the processor 11 takes Yes in Act 30, and then proceeds to the processing in Act 31. The processor 11 executes indication data generation processing in Act 31.

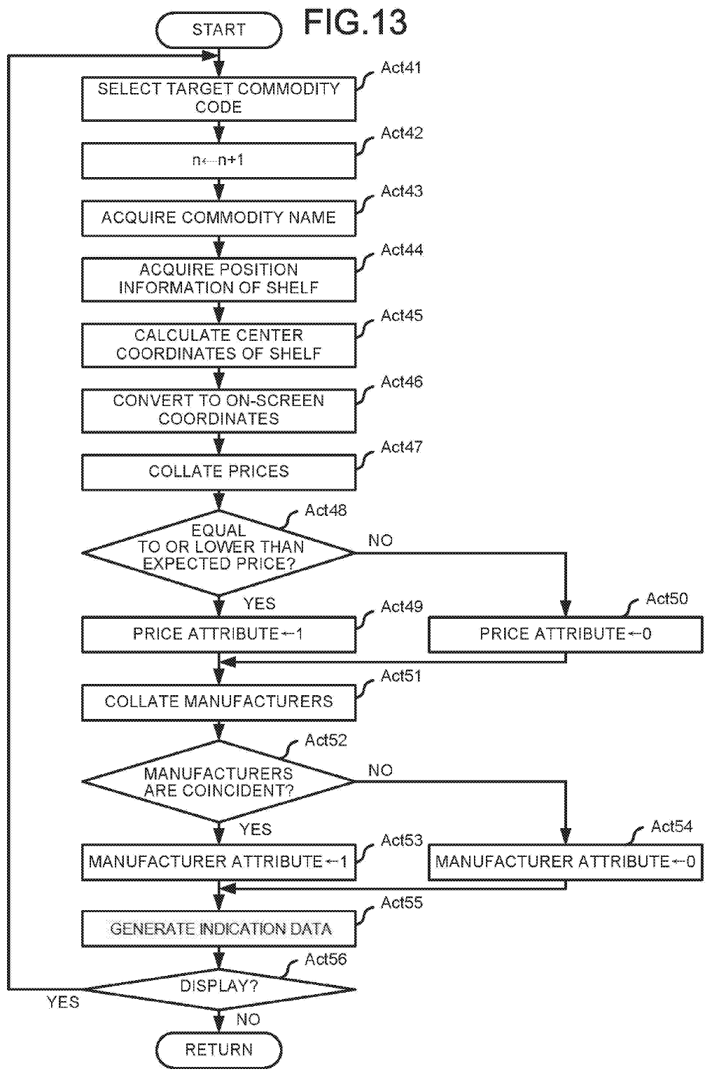

FIG. 13 is a flowchart depicting the indication data generation processing. In the indication data generation processing, the processor 11 selects one target commodity code included in the displayed commodity list in Act 41. Hereinafter, the selected target commodity code is referred to as a selected commodity code.

After the selected commodity code has been selected, the processor 11 counts up the counter n by “1” in Act 42. The processor 11 acquires the commodity name of the commodity identified by the selected commodity code from the commodity data record 131R including the selected commodity code in Act 43. The processor 11 acquires the in-store position information from the shelf data record 132R including the shelf code included in the commodity data record 131R in Act 44. Then, the processor 11 calculates center coordinates of a commodity shelf from the XY coordinates of the upper surface of the commodity shelf included in the in-store position information in Act 45.

After the center coordinates of the commodity shelf have been calculated, the processor 11 converts the center coordinates to on-screen coordinates of the real time image displayed on the display device 36 of the in-store terminal 3 in Act 46. As described above, a real time image showing the image capturing area recognized in Act 22 is displayed on the display device 36 of the in-store terminal 3. The processor 11 specifies a position indicated by the center coordinates calculated in Act 45 from the image capturing area. Then, the processor 11 converts the position to the on-screen coordinates displayed on the display device 36.

After the center coordinates have been converted to the on-screen coordinates of the real time image, the processor 11 acquires the price of the commodity identified by the selected commodity code from the commodity data record 131R including the selected commodity code in Act 47. The processor 11 then collates the price with the expected price included in the purchase support data record 133R of which the record number is coincident with the counter m.

The processor 11 determines whether or not the price is equal to or lower than the expected price in Act 48. If the price is equal to or lower than the expected price, the processor 11 takes Yes in Act 48, and then proceeds to the processing in Act 49. The processor 11 sets the value of the price attribute to “1” in Act 49. On the other hand, if the price is higher than the expected price, the processor 11 takes No in Act 48, and then proceeds to the processing in Act 50. The processor 11 sets the value of the price attribute to “0” in Act 50.

After the value of the price attribute has been set in Act 49 or Act 50, the processor 11 acquires the manufacturer of the commodity identified by the selected commodity code from the commodity data record 131R including the selected commodity code in Act 51. The processor 11 then collates the manufacturer with the expected manufacturer included in the purchase support data record 133R of which the record number is coincident with the counter m.

The processor 11 determines whether or not the manufacturers are coincident in Act 52. If the manufacturers are coincident, the processor 11 takes Yes in Act 52, and then proceeds to the processing in Act 53. The processor 11 sets the value of the manufacturer attribute to “1” in Act 53. On the other hand, if the manufacturers are not coincident, the processor 11 takes No in Act 52, and then proceeds to the processing in Act 54. The processor 11 sets the value of the manufacturer attribute to “0” in Act 54.

After the value of the manufacturer attribute has been set in Act 53 or Act 54, the processor 11 generates the indication data record 333R in Act 55. Specifically, the processor 11 generates the indication data record 333R using the commodity name acquired in Act 43, the on-screen coordinates calculated in Act 46, the price attribute set in Act 49 or Act 50, the manufacturer attribute set in Act 53 or Act 54, the record number which is the value of the counter n and the check flag CF of which the value is “0”.

After the indication data record 333R has been generated, the processor 11 determines whether or not another target commodity code included in the purchase support data record 133R is included in the displayed commodity list in Act 56. If another target commodity code is included in the displayed commodity list, the processor 11 takes Yes in Act 56, and then returns to the processing in Act 41. Then, the processor 11 selects the target commodity code, and repeatedly executes the processing in Act 42 to Act 56 described above.

On the other hand, if no other target commodity code is included in the displayed commodity list, the processor 11 takes No in Act 56, and stops the indication data generation processing. If the indication data generation processing is stopped, the processor 11 returns to the processing in Act 27 in FIG. 12. Specifically, the processor 11 counts up the counter m by “1”. If the counter m is equal to or less than the number M of the purchase support data records 133R, the processor 11 acquires the purchase support data record 133R of which the record number is coincident with the counter m from the purchase support file 133. Then, if the target commodity code included in the purchase support data record 133R is included in the displayed commodity list, the processor 11 executes the indication data generation processing described above.

In this way, the processor 11 generates the indication data record 333R including the commodity name, the on-screen coordinates, the price attribute and the manufacturer attribute of the commodity identified by the target commodity code each time the target commodity code included in the purchase support data record 133R is included in the displayed commodity list. The generated indication data record 333R is stored in the volatile memory area of the main memory 12 in the order of the record number.

Here, the processor 11 of the server 1 functions as an acquiring module for acquiring the information of the purchase-planned commodity that the user of the image capturing device 38 plans to purchase and the requirement information for the purchase-planned commodity of the user by executing the processing in Act 26 to Act 29.

If the counter m exceeds the number M of the purchase support data records 133R, the processor 11 takes No in Act 28, and then proceeds to the processing in Act 32. The processor 11 determines whether or not the indication data record 333R is generated in Act 32. If at least one indication data record 333R is generated in the indication data generation processing described above, the processor 11 takes Yes in Act 32, and then proceeds to the processing in Act 33. The processor 11 performs control to transmit all the indication data records 333R generated in the indication data generation processing to the in-store terminal 3 in Act 33. Through this control, the indication data record 333R is wirelessly transmitted from the first communication interface 15 to the in-store terminal 3 via the network 4.

On the other hand, if no indication data record 333R is generated, the processor 11 takes No in Act 32, and skips the processing in Act 33. After that, the processor 11 returns to the processing in Act 8 in FIG. 11. The processing performed by the processor 31 of the in-store terminal 3 that receives the indication data record 333R is described below.

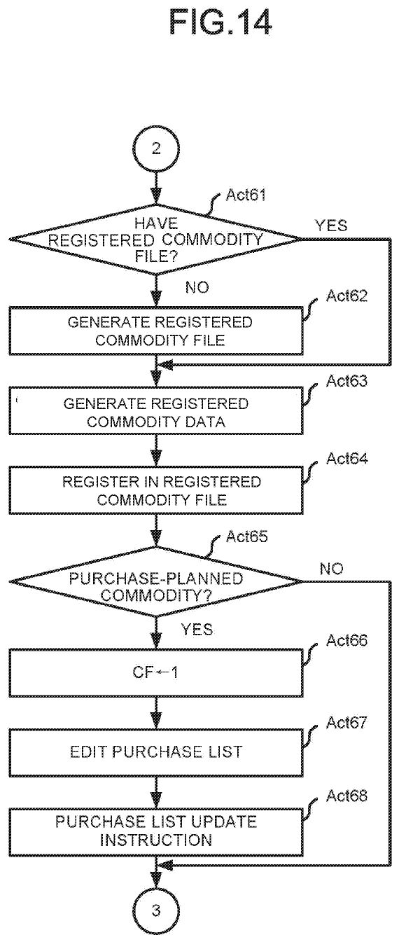

If the data of a code symbol is received through the first communication interface 15 in the standby state in Act 8 to Act 10, the processor 11 takes Yes in Act 9, and then proceeds to the processing in Act 61 in FIG. 14. The data of the code symbol is transmitted from the in-store terminal 3 to the server 1 each time the code symbol including the commodity code is read by the reading device 37 of the in-store terminal 3 as described above.

The processor 11 determines whether or not the registered commodity file 134 associated with the login ID acquired in the processing in Act 2 has been generated in Act 61. If the corresponding registered commodity file 134 has not been generated yet, the processor 11 takes No in Act 61, and then proceeds to the processing in Act 62. The processor 11 generates the registered commodity file 134 associated with the login ID acquired in Act 2 in the auxiliary storage device 13 in Act 62. If the corresponding registered commodity file 134 has been already generated, the processor 11 takes Yes in Act 61, and skips the processing in Act 62.

The processor 11 generates the registered commodity data record 134R in Act 63. Specifically, the processor 11 retrieves the commodity database 131 with the commodity code included in the code symbol to acquire the price from the commodity data record 131R including the commodity code. Then, the processor 11 generates the registered commodity data record 134R by adding the login ID and the record number to the commodity code, the price and the quantity whose value is “1”.

After the registered commodity data record 134R has been generated, the processor 11 registers the registered commodity data record 134R in the registered commodity file 134 associated with the login ID included in the registered commodity data record 134R in Act 64. If the registered commodity data record 134R including the same commodity code has already been registered in the registered commodity file 134, the processor 11 increases the quantity in the registered commodity data record 134R by “1”, but does not register the generated registered commodity data record 134R.

After the registered commodity data record 134R has been registered or the quantity therein has been increased by “1”, the processor 11 determines whether or not the registered commodity is the purchase-planned commodity in Act 65. Specifically, the processor 11 determines whether or not there is a purchase support data record 133R in which the commodity code included in the registered commodity data record 134R is recorded as the target commodity code among the purchase support data records 133R of which the user ID is coincident with the login ID included in the registered commodity data record 134R. If there is no corresponding purchase support data record 133R, the registered commodity is not the purchase-planned commodity. In this case, the processor 11 takes No in Act 65.

On the other hand, if there is a corresponding purchase support data record 133R, the registered commodity is the purchase-planned commodity. In this case, the processor 11 takes Yes in Act 65, and then proceeds to the processing in Act 66. The processor 11 changes the value of the check flag CF in the purchase support data record 133R to “1” in Act 66. Then, the processor 11 edits the purchase list in Act 67. Specifically, the processor 11 acquires data of the record number, the commodity category, the expected price, the expected manufacturer and the check flag CF from all the purchase support data records 133R of which the user ID is coincident with the login ID in the registered commodity data record 134R. Then, the processor 11 generates the purchase list which is an aggregate of the purchase plan records 633R from the data acquired from the purchase support data record 133R.

After the purchase list has been generated, the processor 11 instructs to update the purchase list in Act 68. In response to the instruction, an update instruction of the purchase list is wirelessly transmitted from the first communication interface 15 through the network 4. The update instruction includes the purchase list, i.e., an aggregate of the purchase plan records 633R. The update instruction is received by the user terminal 6 in which the user ID in the purchase plan record 633R included in the update instruction is set in the user ID memory area 632.

In the user terminal 6 receiving the update instruction, the data in the purchase list memory area 633 is updated to the aggregate of the purchase plan records 633R included in the update instruction. The operation of the user terminal 6 at the time the data in the purchase list memory area 633 is updated is described below.

The processor 11 that has transmitted the update instruction of the purchase list returns to the processing in Act 8 in FIG. 11. The processor 11 returns to the processing in Act 8 also when No is taken in Act 65.

In the standby state in Act 8 to Act 10, if the checkout command is received, the processor 11 takes Yes in Act 10, and then proceeds to the processing in Act 11. The checkout command is wirelessly transmitted from the in-store terminal 3 to the server 1 if a checkout button is operated in the in-store terminal 3 as described above. The processor 11 acquires a login ID from the checkout command in Act 11. Then, the processor 11 generates a registered commodity list including the commodity code, the price and the quantity from the registered commodity data record 134R in the registered commodity file 134 associated with the acquired login ID, and transmits the generated registered commodity list to the checkout apparatus 2 through the communication line 5 in Act 12. The processor 11 then terminates the information processing for the customer who has registered the commodity with the in-store terminal 3. In the checkout apparatus 2 receiving the registered commodity list, a known checkout processing is performed.

Next, a processing performed by the processor 31 of the in-store terminal 3 receiving the indication data record 333R is described.

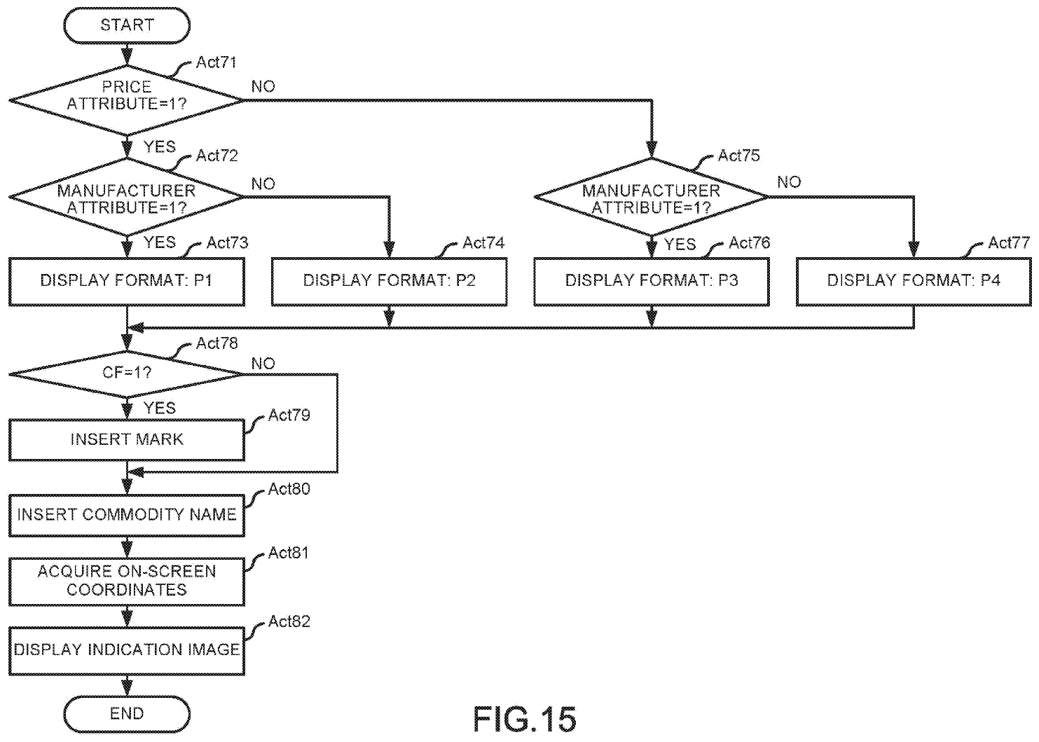

FIG. 15 is a flowchart depicting a processing executed according to a program at the time the in-store terminal 3 receives the indication data record 333R. The program is stored in the main memory 32 or the auxiliary storage device 33. The contents of the processing shown in the flowchart in FIG. 15 and described below are merely an example. The procedures of the processing are not particularly limited as long as the same results can be achieved.

As described above, the processor 31 overwrites the indication data memory area 333 with the indication data record 333R received from the server 1 to store the indication data record 333R. Thereafter, the processor 31 executes an information processing having the procedures shown in the flowchart in FIG. 15 on the indication data record 333R stored in the indication data memory area 333. Here, if a plurality of indication data records 333R is received, the same information processing is performed on each of them.

First, the processor 31 checks the value of the price attribute in the indication data record 333R in Act 71. If the value of the price attribute is “1”, the processor 31 takes Yes in Act 71, and then proceeds to the processing in Act 72. The processor 31 checks the value of the manufacturer attribute in the indication data record 333R in Act 72. If the value of the manufacturer attribute is “1”, the processor 31 takes Yes in Act 72, and then proceeds to the processing in Act 73. The processor 31 sets a display format of an indication image 80 to a pattern P1 in Act 73.

In Act 72, if the value of the manufacturer attribute is “0”, the processor 31 takes No, and then proceeds to the processing in Act 74. The processor 31 sets the display format of the indication image 80 to a pattern P2 in Act 74.

In Act 71, if the value of the price attribute is “0”,the processor 31 takes No, and then proceeds to the processing in Act 75. The processor 31 checks the value of the manufacturer attribute in the indication data record 333R in Act 75. If the value of the manufacturer attribute is “1”, the processor 31 takes Yes in Act 75, and then proceeds to the processing in Act 76. The processor 31 sets the display format of the indication image 80 to a pattern P3 in Act 76.

In Act 75, if the value of the manufacturer attribute is “0”, the processor 31 takes No, and then proceeds to the processing in Act 77. The processor 31 sets the display format of the indication image 80 to a pattern P4 in Act 77.

FIG. 16 is an example of the indication image 80. The indication image 80 is formed by combining a balloon graphic 81 and a circular graphic 82. In the balloon graphic 81, a commodity name is inserted. A background color of the circular graphic 82 is determined according to the pattern of the display format. For example, it is defined that the background color of the pattern P1 is red, that the background color of the pattern P2 is orange, that the background color of the pattern P3 is green, and that the background color of the pattern P4 is yellow.

If the patterns P1 to P4 of display formats are set, the processor 31 checks the value of the check flag CF in the indication data record 333R in Act 78. If the value of the check flag CF is “1”, the processor 31 takes Yes in Act 78, and then proceeds to the processing in Act 79. The processor 31 inserts a mark indicating that the corresponding commodity has already been taken in the circular graphic 82 of the indication image 80 in Act 79. The mark indicating that the corresponding commodity has already been taken is, for example, a star mark.

On the other hand, if the value of the check flag CF is “0”, the processor 31 takes No in Act 78. If No is taken in Act 78, or if the processing in Act 79 is terminated, the processor 31 proceeds to the processing in Act 80. The processor 31 acquires the commodity name from the indication data record 333R in Act 80. The processor 31 inserts the commodity name into the balloon graphic 81 of the indication image 80.

Thereafter, the processor 31 acquires the on-screen coordinates from the indication data record 333R in Act 81. Then, the processor 31 controls the image processing section 39 to perform an image processing using the augmented reality technology such that the indication image 80 is displayed by being superimposed on a real time image 90 at a position specified by the on-screen coordinates on the real time image 90 in Act 82. Through the above, the processor 31 terminates the information processing on one indication data record 333R.

Here, the processor 11 of the server 1 that executes the processing in Act 30 to Act 33 cooperate with the processor 31 of the in-store terminal 3 that executes the processing in Act 71 to Act 82 to function as a control module and a determining module.

Specifically, the processor 31 controls the display device 36 to display the real time image 90 captured by the image capturing device 38. If the purchase-planned commodity is included in the sales commodities detected by the detection module, the processor 11 generates the indication data record 333R so as to display the indication image 80 by superimposing the indication image 80 on the real time image 90 at a position where the purchase-planned commodity is shown. The processor 11 generates the indication data record 333R such that the display format of the indication image 80 changes depending on whether the purchase-planned commodity satisfies the requirement indicated by the requirement information. Thus, the processor 31 displays the indication image 80 by superimposing the indication image 80 on the real time image 90 at a position where the purchase-planned commodity is shown, and changes the display format of the indication image 80 according to whether the purchase-planned commodity satisfies the requirement indicated by the requirement information. Specifically, the processor 31 changes the background color of the circular graphic 82 in the indication image 80.

More specifically, the processor 31 changes the display format of the indication image 80 depending on whether the sales price of the purchase-planned commodity is lower than or equal to the price included in the requirement information. Alternatively, the processor 31 changes the display format of the indication image 80 depending on whether the manufacturer of the purchase-planned commodity is the manufacturer included in the requirement information.

The processor 11 determines whether or not the purchase-planned commodity has already been taken. Then, the processor 11 generates the indication data record 333R such that the display format of the indication image 80 further differs depending on whether the purchase-planned commodity contained in the sales commodities detected by the detection module is already taken. Thus, the processor 31 further changes the display format of the indication image 80 depending on whether the purchase-planned commodity is already taken. Specifically, a star mark is displayed in the circular graphic 82 of the indication image 80.

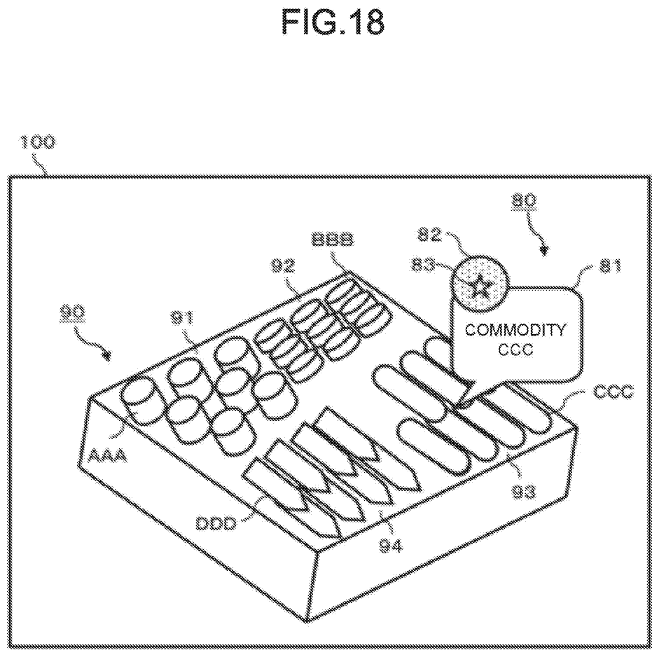

FIG. 17 shows an example of a screen 100 in which the indication image 80 is displayed by being superimposed on the real time image 90 at the position indicated by the on-screen coordinates on the real time image 90. The real time image 90 shows a commodity shelf 91 on which a commodity AAA is displayed, a commodity shelf 92 on which a commodity BBB is displayed, a commodity shelf 93 on which a commodity CCC is displayed, and a commodity shelf 94 on which a commodity DDD is displayed. The indication image 80 is approximately displayed at the center of the commodity shelf 93. The indication image 80 indicates that the commodity CCC displayed on the commodity shelf 93 is a commodity belonging to the commodity category designated by the customer as the purchase-planned commodity.

Therefore, the customer can know from the screen 100 that the commodity CCC planned to be purchased is displayed on the commodity shelf 93 in the moving direction of the shopping cart 7.

Moreover, if the background color of the circular graphic 82 in the indication image 80 is red, the price of the commodity CCC is equal to or lower than the expected price and the manufacturer thereof is coincident with the expected manufacturer. If the background color of the circular graphic 82 is orange, the price of the commodity CCC is equal to or lower than the expected price but the manufacturer thereof is not coincident with the expected manufacturer. If the background color of the circular graphic 82 is green, the manufacturer of the commodity CCC is coincident with the expected manufacturer but the price thereof is higher than the expected price. If the background color of the circular graphic 82 is yellow, the manufacturer of the commodity CCC is not coincident with the expected manufacturer and the price is higher than the expected price.

Therefore, the customer can know from the background color of the circular graphic 82 whether the commodity CCC satisfies both the expected price and the expected manufacturer, either one of them or neither.

Among the customers, some customers may only purchase a commodity that satisfies the requirements in both the price and the manufacturer even though the commodity belongs to the same commodity category. Alternatively, some customers may purchase a commodity that only satisfies the requirement in the price, or a commodity that only satisfies the requirement in the manufacturer. Some customers may purchase a commodity that does not satisfy the requirements in both the price and the manufacturer as long as the commodity belongs to the same commodity category.

According to the present embodiment, since any customer described above can be guided to a display place of a commodity that satisfies the requirement of the customer, the purchase support apparatus can effectively offer the purchase support. Specifically, the customer can be guided to a display place of a commodity that satisfies the requirement in the price or a display place of a commodity that satisfies the requirement in the manufacturer.

FIG. 18 shows a display when the commodity CCC has already been taken, i.e., when the value of the check flag CF is set to “1” based on the screen 100 shown in FIG. 17. In this case, a star mark 83 is inserted in the circular graphic 82. Thus, the customer can know that the commodity CCC indicated by the indication image 80 has already been taken. As a result, the commodity that has already been taken is prevented from being taken repeatedly, and thus, the purchase support can be effectively offered from this point.

Next, the operation of the user terminal 6 when the data in the purchase list memory area 633 is updated is described.

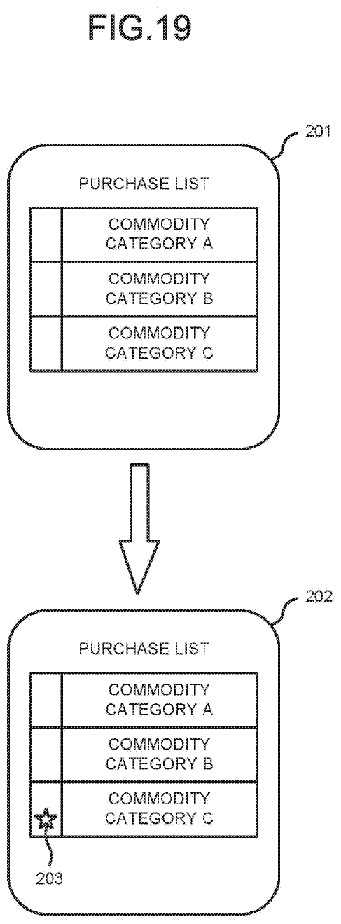

FIG. 19 shows transition of an image displayed on the display device 66 of the user terminal 6. In FIG. 19, an image 201 shows the purchase list before update, and an image 202 shows the purchase list after update. In this example, the purchase list is updated since the customer who plans to purchase a commodity belonging to a commodity category A, a commodity belonging to a commodity category B and a commodity belonging to a commodity category C, have already taken the commodity belonging to the commodity category C. As shown in FIG. 19, by updating the purchase list, a star mark 203 indicating that the commodity belonging to the commodity category C has been taken is displayed. Therefore, the customer can easily know from the transition of the image that the commodity belonging to the commodity category C has already been taken. Furthermore, the star mark 203 is automatically displayed when the purchase-planned commodity is taken despite whether the customer is aware of that the purchase-planned commodity has already been taken. Therefore, the purchase support can be effectively offered from this point.

In the above embodiment, a mechanism for deleting the purchase support data record 133R stored in the purchase support file 133 during the purchase is not considered. For this reason, even if a customer intends to cancel the purchase of the commodity in the purchase list during the purchase, if the commodity that is not intended to be purchased is included in the displayed commodity list obtained from the captured image, the indication image 80 is still displayed on the display device 36 of the in-store terminal 3.

Therefore, a specific example of deleting the purchase support data record 133R during the purchase is described below. First, data of a deletion flag is added to the purchase support data record 133R shown in FIG. 9. A graphic for deletion is added to the indication image 80 shown in FIG. 16. The graphic for deletion is, for example, a triangular graphic, and is displayed by being superimposed on the balloon graphic 81.

After performing the image processing in Act 82 in FIG. 15, the processor 31 of the in-store terminal 3 determines whether or not the graphic for deletion in the indication image 80 displayed on the display device 36 has been selected or operated. If the display device 36 is a touch panel, the processor 31 determines whether or not the graphic for deletion has been touched. Then, if the graphic for deletion has been touched, the processor 31 controls the wireless communication device 34 to output a command for instructing to delete a commodity whose commodity name is displayed in the balloon graphic 81 of the indication image 80 corresponding to the graphic for deletion to the server 1. Through this control, the wireless communication device 34 transmits a deletion instruction command to the server 1 via the network 4. The deletion instruction command includes the login ID input at the time of login on the in-store terminal 3 and the commodity name displayed in the balloon graphic 81. Alternatively, the deletion instruction command may include the above-described login ID and a commodity code of the commodity whose commodity name is displayed in the balloon graphic 81.

If the deletion instruction command is received, the processor 11 of the server 1 extracts the purchase support data record 133R including the user ID that is coincident with the login ID included in the command from the purchase support file 133. Furthermore, the processor 11 selects, from the detected purchase support data records 133R, a purchase support data record 133R in which the commodity code included in the command or the commodity code corresponding to the commodity name is set as the target commodity code. Then, the processor 11 sets a deletion flag in the selected purchase support data record 133R. Thereafter, the processor 11 deletes the purchase support data record 133R in which the deletion flag is set from the processing targets.

By adopting such a configuration, the purchase support data record 133R stored in the purchase support file 133 can be substantially deleted during the purchase.

The embodiments of the purchase support apparatus that can effectively offer the purchase support are described above; however, the present invention is not limited thereto. Below, other embodiments are described.

In the above embodiment, the information relating to the price and the information relating to the manufacturer are shown as the requirement information. The requirement information is not limited to the information relating to the price and the information relating to the manufacturer. For example, information relating to a manufacturing date may be added to the commodity data record 131R, and the information relating to the manufacturing date may be used as the requirement information.

In the above embodiment, after logging in to the user terminal 6, data of the purchase list is transmitted from the user terminal 6 to the server. For this point, the data of the purchase list may be transmitted from the user terminal 6 to the server before the user logs in to the user terminal 6. In that case, the user terminal 6 may transmit the data of the purchase list to the server 1 via the Internet which is a wide area network. In this way, the customer can transmit the data relating to the purchase list to the server 1 from, for example, a personal computer at home.

The in-store terminal 3 may not be attached to the shopping cart 7. The in-store terminal 3 may be a portable type terminal, and the customer uses the image capturing device 38 of the in-store terminal 3 to capture an image showing the inside of the retail store.

In the above embodiment, the login ID and the user ID of the same customer are coincident with each other. For this point, a data table is prepared in which the login ID is associated with the user ID of the same customer. Then, the processor 11 refers to the above-described data table to determine whether or not the user ID associated with the purchase list is coincident with the login ID input at the time of logging in to the in-store terminal 3 at the time of collation in Act 6 in FIG. 11. In this way, the user ID used at the time the user prepares the purchase list may be different from the login ID input at the time of logging in to the in-store terminal 3.

In the above embodiment, the processor 11 of the server 1 calculates the center coordinates of the commodity shelf in Act 45 in FIG. 13. For this point, the processor 11 may not calculate the center coordinates of the commodity shelf. For example, coordinates of a corner of the commodity shelf may be calculated.

In the above embodiment, the background color of the circular graphic 82 is changed according to the pattern of the display format. For this point, the change of the circular graphic 82 is not limited to the background color. For example, brightness, a size, and the like of the circular graphic 82 may be changed according to the pattern of the display format. A shape of the graphic to be combined with the balloon graphic 81 may be changed according to the pattern of the display format. The change of the circular graphic 82 is not particularly limited as long as the customer can determine whether the expected price is satisfied or the expected manufacturer is satisfied according to the indication image 80.

The configuration of the indication image 80 is not limited to the combination of the above-described balloon graphic 81 and the circular graphic 82. The configuration of the indication image 80 is not particularly limited as long as the customer can determine whether the purchase-planned commodity is displayed and the purchase-planned commodity satisfies the requirement indicated by the requirement information.

The mark indicating that the commodity has already been taken is not limited to the star mark. The mark may be, for example, a check mark. The shape of the mark is not particularly limited as long as the customer can recognize that the commodity is already taken.

If the display device 36 of the in-store terminal 3 is a touch panel, and the customer touches the indication image 80 displayed on the screen 100 of the display device 36, the server 1 is notified that the commodity indicated by the indication image 80 is already taken. Alternatively, if the display device 66 of the user terminal 6 is a touch panel, and the customer touches the commodity category included in the purchase list displayed on the screen 100 of the display device 66, the server 1 is notified that the commodity belonging to the commodity category is already taken. In any case, the processor 11 of the server 1 receiving the notification executes the processing in Act 66 to Act 68 in FIG. 14. The processor 11 executes the processing in Act 21 to Act 33 in FIG. 12 each time the image data is received from the in-store terminal 3. Thus, in the in-store terminal 3 and the user terminal 6, in conjunction with each other, the star marks 83 and 203 indicating that the commodities are already taken are displayed for the commodities that are already taken.

In such an embodiment, the reading device 37 can be omitted from the in-store terminal 3. Specifically, the registered commodity may be registered by a general POS (Point Of Sales) terminal.

If the user terminal 6 comprises the image capturing device such as a camera, the information relating to the purchase support may be displayed on the user terminal 6. In this case, the in-store terminal 3 is unnecessary.

The storage destination of the commodity database 131 and the shelf database 132 may not be the auxiliary storage device 13 of the server 1. For example, the commodity database 131 and the shelf database 132 may be stored on a computer other than the server 1. The computer may be provided by cloud computing.

The transfer of the program to the server 1 or the in-store terminal 3 can be performed by recording the program on a removable recording medium or through communication via a network. The recording medium is not particularly limited as long as it can store programs such as a CD-ROM (Compact Disc Read-Only Memory), a memory card, etc., and it can be read by the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A purchase support system comprising:
a server including
a memory that stores a list of commodities and respective purchase conditions specified by a customer,
a first network interface, and
a first processor; and
a terminal including
a display,
a camera configured to acquire an image,
a second network interface, and
a second processor configured to control the second network interface to transmit the acquired image to the server, wherein
the first processor is configured to
upon receipt of the image from the terminal, identify one or more commodities included in the image,
determine first commodities that are included in the list of commodities and are also identified in the image,
generate first information indicating whether or not the first commodities satisfy the respective purchase conditions,
generate second information indicating where the first commodities are displayed, and
control the first network interface to transmit the first and second information to the terminal, and
the second processor is further configured to
upon receipt of the first and second information, control the display to display, in the acquired image, one or more guidance images each indicating a location of one of the first commodities and whether or not the first commodity satisfies the corresponding purchase condition.

2. The system according to claim 1, wherein
each purchase condition includes a condition of a price for the corresponding commodity specified by the customer, and
each guidance image is displayed in a different manner depending on whether or not a sales price of the first commodity is higher than the price specified by the customer.

3. The system according to claim 2, wherein
the guidance image is displayed in a different background color depending on whether or not the sales price is higher than the price specified by the customer.

4. The system according to claim 1, wherein
each purchase condition includes a condition of a provider for the corresponding commodity specified by the customer, and
each guidance image is displayed in a different manner depending on whether or not a provider of the first commodity is the provider specified by the customer.

5. The system according to claim 4, wherein
the guidance image is displayed in a different background color depending on whether or not the provider of the first commodity is the provider specified by the customer.

6. The system according to claim 1, wherein
the first processor is further configured to
determine whether or not each first commodity is registered, and
control the first network interface to transmit to the terminal fourth information indicating whether or not the first commodities are registered, and
each guidance image is displayed in a different manner depending on whether or not the first commodity is registered.

7. The system according to claim 6, wherein
each guidance image includes a name of the first commodity and an icon indicating whether or not the first commodity is registered.

8. The system according to claim 1, wherein
the first processor determines the commodities included in the image by recognizing one or more shelves included in the image and specifying the commodities displayed on the shelves.

9. The system according to claim 1, wherein
the terminal is attached to a shopping cart.

10. The system according to claim 1, wherein
the terminal is a mobile terminal operated by the customer.

11. A method for controlling a purchase support system, the method comprising:
storing a list of commodities and respective purchase conditions specified by a customer;
acquiring an image inside a store;
identifying one or more commodities included in the image;
determining first commodities that are included in the list of commodities and are also identified in the image;
generating first information indicating whether or not the first commodities satisfy the respective purchase conditions;
generating second information indicating where the first commodities are displayed; and
displaying, in the acquired image, one or more guidance images each indicating a location of one of the first commodities and whether or not the first commodity satisfies the corresponding purchase condition.

12. The method according to claim 11, wherein
each purchase condition includes a condition of a price for the corresponding commodity specified by the customer, and
each guidance image is displayed in a different manner depending on whether or not a sales price of the first commodity is higher than the price specified by the customer.

13. The method according to claim 12, wherein
the guidance image is displayed in a different background color depending on whether or not the sales price is higher than the price specified by the customer.

14. The method according to claim 11, wherein
each purchase condition includes a condition of a provider for the corresponding commodity specified by the customer, and
each guidance image is displayed in a different manner depending on whether or not a provider of the first commodity is the provider specified by the customer.

15. The method according to claim 14, wherein
the guidance image is displayed in a different background color depending on whether or not the provider of the first commodity is the provider specified by the customer.

16. The method according to claim 11, further comprising:
determining whether or not each first commodity is registered; and
transmitting fourth information indicating whether or not the first commodities are registered, wherein
each guidance image is displayed in a different manner depending on whether or not the first commodity is registered.

17. The method according to claim 16, wherein
each guidance image includes a name of the first commodity and an icon indicating whether or not the first commodity is registered.

18. The method according to claim 11, wherein
the determining one or more commodities included in the image comprises recognizing one or more shelves included in the image and specifying the commodities displayed on the shelves.

19. The method according to claim 11, wherein
the terminal is attached to a shopping cart.

20. A purchase support apparatus comprising:
a memory that stores a list of commodities and respective purchase conditions specified by a customer;
a network interface configured to communicate with a terminal; and
a processor configured to
upon receipt of an image acquired by the terminal via the network interface, determine one or more commodities included in the image,
determine, from the determined commodities, one or more first commodities that are included in the stored list of commodities,
generate first information indicating whether or not the first commodities satisfy the respective purchase conditions,
generate second information indicating where the first commodities are displayed, and
control the first network interface to transmit to the terminal a command together with the first and second information, wherein
the command causes the terminal to display, in the acquired image, one or more guidance images each indicating a location of one of the first commodities and whether or not the first commodity satisfies the corresponding purchase condition.
